(19) United States
(12) Patent Application Publication
(10) Pub. No.: US 2021/0076074 A1
(43) Pub. Date: Mar. 11, 2021

(54) MAXIMUM AND MINIMUM BLOCK SIZES SIGNALING AT HIGH LEVEL SYNTAX FOR VIDEO CODING AND TRANSFORM UNITS

(71) Applicant: QUALCOMM Incorporated, San Diego, CA (US)

(72) Inventors: Yao-Jen Chang, San Diego, CA (US); Muhammed Zeyd Coban, Carlsbad, CA (US); Vadim Seregin, San Diego, CA (US); Adarsh Krishnan Ramasubramonian, Irvine, CA (US); Marta Karczewicz, San Diego, CA (US)

(21) Appl. No.: 17/014,492

(22) Filed: Sep. 8, 2020

Related U.S. Application Data
(60) Provisional application No. 62/899,032, filed on Sep. 11, 2019.
(60) Provisional application No. 62/909,135, filed on Oct. 1, 2019.

(51) Int. Cl. H04N 19/70; H04N 19/186; H04N 19/96

(52) U.S. Cl. CPC H04N 19/70; H04N 19/96; H04N 19/186

(57) ABSTRACT

An example device for coding video data codes, in a parameter set, a first syntax element indicative of a luma coding tree block size of coding tree units (CTUs) to which the parameter set is applicable minus 5. The device codes, in the parameter set, a second syntax element indicative of a minimum luma coding block size minus 2 of luma coding blocks to which the parameter set is applicable, wherein a value of the second syntax element is in a range of 0 to a value based on the first syntax element, inclusive. The device codes the luma coding blocks to which the parameter set is applicable in accordance with the first syntax element and the second syntax element in the parameter set.

This application claims priority to U.S. Provisional Application No. 62/899,032, filed Sep. 11, 2019, and to U.S. Provisional Application No. 62/909,135, filed Oct. 1, 2019, the entire content of each of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for signaling block sizes of coding units, transform and transform skip signaling, and subpicture signaling. The techniques may be applied to the Versatile Video Coding standard and other future video coding standards.

In one example, a method of encoding video data includes encoding, in a parameter set, a first syntax element indicative of a luma coding tree block size of coding tree units (CTUs) to which the parameter set is applicable minus 5, encoding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and encoding the luma coding blocks to which the parameter set is applicable in accordance with the first syntax element and the second syntax element in the parameter set.

In one example, a method of decoding video data includes decoding, in a parameter set, a first syntax element indicative of a luma coding tree block size of coding tree units (CTUs) to which the parameter set is applicable minus 5, decoding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and decoding the luma coding blocks to which the parameter set is applicable in accordance with the first syntax element and the second syntax element in the parameter set.

In another example, a device includes memory configured to store video data, and one or more processors implemented in circuitry and communicatively coupled to the memory, the one or more processors being configured to: encode, in a parameter set, a first syntax element indicative of a luma coding tree block size of coding tree units (CTUs) to which the parameter set is applicable minus 5; encode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and encode the luma coding blocks to which the parameter set is applicable in accordance with the first syntax element and the second syntax element in the parameter set.

In another example, a device includes memory configured to store video data, and one or more processors implemented in circuitry and communicatively coupled to the memory, the one or more processors being configured to: decode, in a parameter set, a first syntax element indicative of a luma coding tree block size of coding tree units (CTUs) to which the parameter set is applicable minus 5; decode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and decode the luma coding blocks to which the parameter set is applicable in accordance with the first syntax element and the second syntax element in the parameter set.

In another example, a non-transitory computer-readable storage medium has stored thereon instructions that, when executed, cause one or more processors to: code, in a parameter set, a first syntax element indicative of a luma coding tree block size of coding tree units (CTUs) to which the parameter set is applicable minus 5; code, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and code the luma coding blocks to which the parameter set is applicable in accordance with the first syntax element and the second syntax element in the parameter set.

In another example, a device includes means for coding, in a parameter set, a first syntax element indicative of a luma coding tree block size of coding tree units (CTUs) to which the parameter set is applicable minus 5, means for coding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and means for coding the luma coding blocks to which the parameter set is applicable in accordance with the first syntax element and the second syntax element in the parameter set.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a block diagram illustrating an example video encoder that may perform the techniques of this disclosure.

FIG. 4 is a block diagram illustrating an example video decoder that may perform the techniques of this disclosure.

FIG. 5 is a flowchart illustrating a method of signaling according to the techniques of this disclosure.

FIG. 6 is a flowchart illustrating a method of encoding video data according to techniques of this disclosure.

FIG. 7 is a flowchart illustrating a method of decoding video data according to techniques of this disclosure.

### DETAILED DESCRIPTION

In some example video coding standards specifications, certain relationships, such as a minimum coding block size and a maximum coding block size are not well defined. For example, if a video coding standard specification permits a minimum coding block size to be larger than a coding block size or maximum coding block size, a video coder (e.g., video encoder or video decoder) may incorrectly encode or decode video data when attempting to code a minimum coding block size that is larger than the coding block size or maximum coding block size.

According to the techniques of this disclosure, signaling for coding block sizes may be restricted such that a video encoder may not signal a minimum coding block size that is larger than a coding block size or a maximum coding block size. This may simplify coder design. Additionally, signaling for transform and transform skip and subpictures signaling may be similarly restricted to simplify coder design and avoid inconsistencies that may lead to incorrect encoding or incorrect decoding.

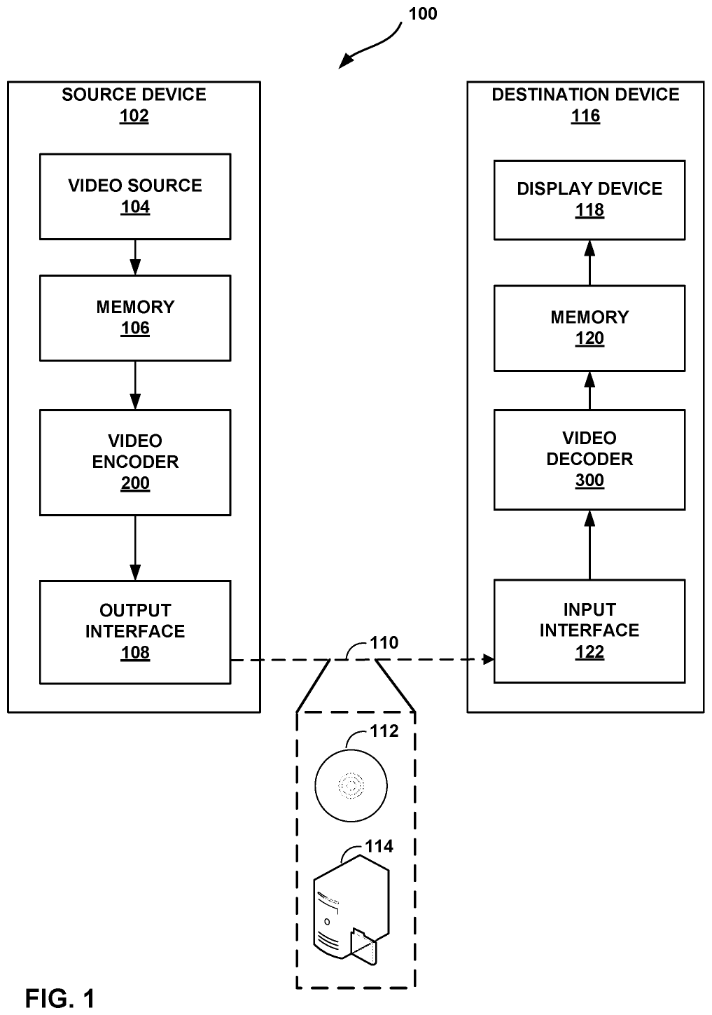

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, video encoding and decoding system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for signaling block sizes, maximum block sizes, and minimum block sizes of coding units, signaling of transform units and transform skip, and/or subpicture signaling. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

Video encoding and decoding system 100 as shown in FIG. 1 is merely one example. In general, any digital video encoding and/or decoding device may perform techniques for signaling block sizes, maximum block sizes and minimum block sizes of coding units, signaling of transform units and transform skip, and/or subpicture signaling. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, video encoding and decoding system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memory 106 and memory 120 may store raw video data, e.g., raw video from video source 104 and raw, decoded video data from video decoder 300. Additionally or alternatively, memory 106 and memory 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memory 106 and memory 120 may store encoded video data, e.g., output from video encoder 200 and input to video decoder 300. In some examples, portions of memory 106 and memory 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). In some examples, the syntax elements may include a syntax element indicative of a size of a video block and a syntax element indicative of a minimum size of a video block.

Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM) or ITU-T H.266, also referred to as Versatile Video Coding (VVC). A draft of the VVC standard is described in Bross, et al. “Versatile Video Coding (Draft 6),” Joint Video Experts Team (JVET) of ITU-T SG 16 WP 3 and ISO/IEC JTC 1/SC 29/WG 11, 15^{th} Meeting: Gothenburg, SE, 3-12 Jul. 2019, JVET-02001-vE (hereinafter “VVC Draft 6”). A more recent draft of the VVC standard is described in Bross, et al. “Versatile Video Coding (Draft 10),” Joint Video Experts Team (JVET) of ITU-T SG 16 WP 3 and ISO/IEC JTC 1/SC 29/WG 11, 19th Meeting: by teleconference, 22 Jun.-1 Jul. 2020, JVET-52001-vA (hereinafter “VVC Draft 10”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM or VVC. According to JEM or VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (×=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of JEM and VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of JEM and VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs), which may include syntax elements indicative of a size of a block and a minimum size of a block, and prediction, and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In accordance with the techniques of this disclosure, a method of encoding video data includes encoding, in a parameter set, a first syntax element indicative of a luma coding tree block size of coding tree units (CTUs) to which the parameter set is applicable minus 5, encoding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and encoding the luma coding blocks to which the parameter set is applicable in accordance with the first syntax element and the second syntax element in the parameter set.

In accordance with the techniques of this disclosure, a method of coding video data includes decoding, in a parameter set, a first syntax element indicative of a luma coding tree block size of coding tree units (CTUs) to which the parameter set is applicable minus 5, decoding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and decoding the luma coding blocks to which the parameter set is applicable in accordance with the first syntax element and the second syntax element in the parameter set.

In accordance with the techniques of this disclosure, a device for encoding video data includes memory configured to store the video data, and one or more processors implemented in circuitry and communicatively coupled to the memory, the one or more processors being configured to: encode, in a parameter set, a first syntax element indicative of a luma coding tree block size of coding tree units (CTUs) to which the parameter set is applicable minus 5; encode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and encode the luma coding blocks to which the parameter set is applicable in accordance with the first syntax element and the second syntax element in the parameter set.

In accordance with the techniques of this disclosure, a device for coding video data includes memory configured to store the video data, and one or more processors implemented in circuitry and communicatively coupled to the memory, the one or more processors being configured to: decode, in a parameter set, a first syntax element indicative of a luma coding tree block size of coding tree units (CTUs) to which the parameter set is applicable minus 5; decode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and decode the luma coding blocks to which the parameter set is applicable in accordance with the first syntax element and the second syntax element in the parameter set.

In accordance with the techniques of this disclosure, a non-transitory computer-readable storage medium has stored thereon instructions that, when executed, cause one or more processors to: code, in a parameter set, a first syntax element indicative of a luma coding tree block size of coding tree units (CTUs) to which the parameter set is applicable minus 5; code, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and code the luma coding blocks to which the parameter set is applicable in accordance with the first syntax element and the second syntax element in the parameter set.

In accordance with the techniques of this disclosure, a device for coding video data includes means for coding, in a parameter set, a first syntax element indicative of a luma coding tree block size of coding tree units (CTUs) to which the parameter set is applicable minus 5, means for coding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and means for coding the luma coding blocks to which the parameter set is applicable in accordance with the first syntax element and the second syntax element in the parameter set.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

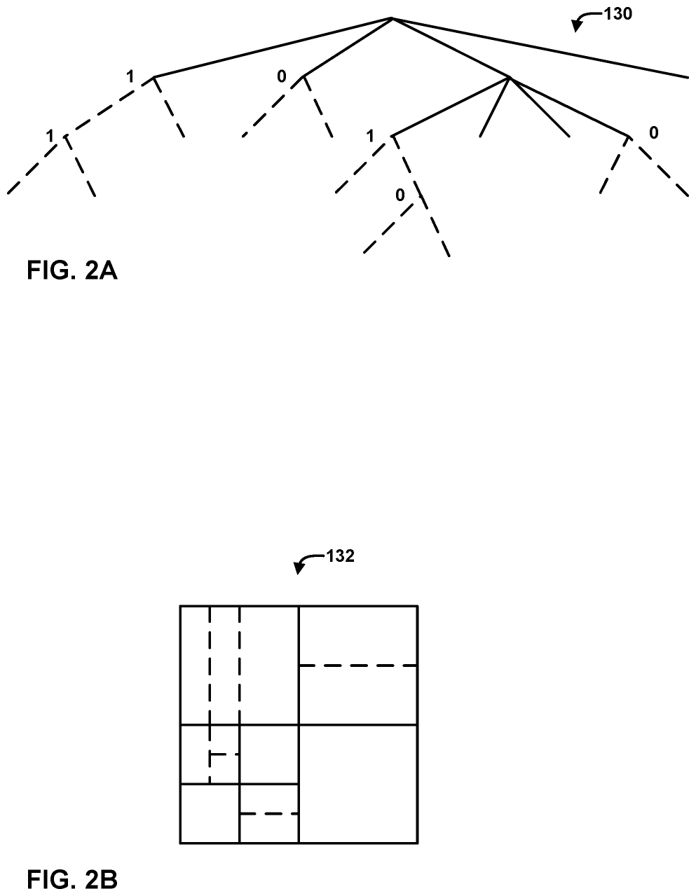

FIGS. 2A and 2B are conceptual diagram illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), then the nodes can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

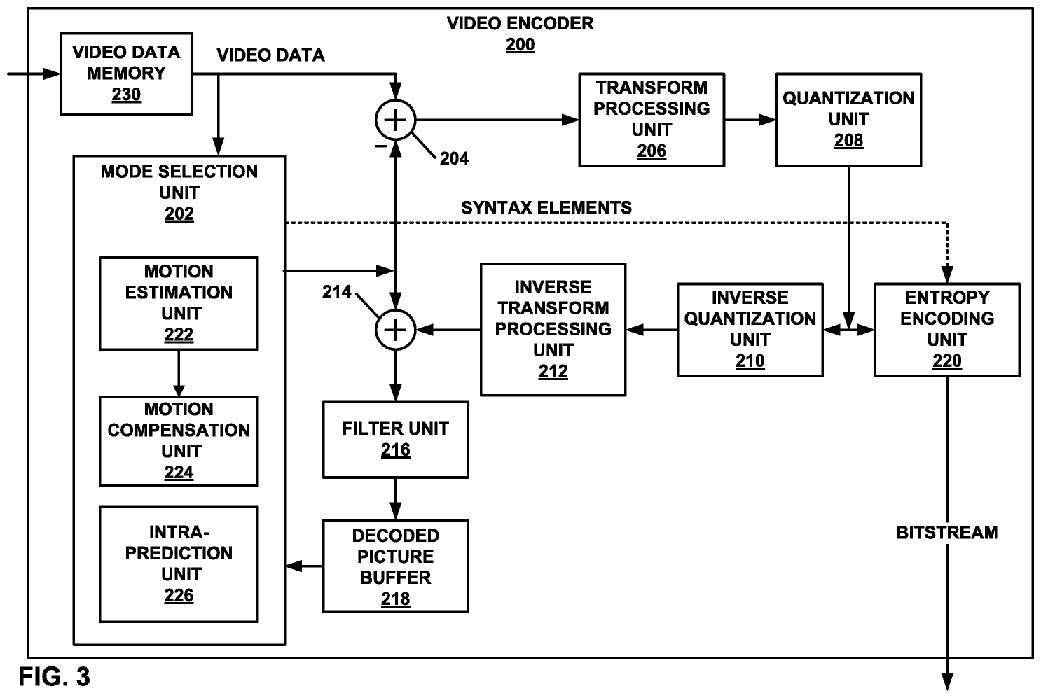

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards, and are applicable generally to video encoding and decoding.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200, such as syntax elements indicative of a luma coding tree block size and indicative of a minimum coding block size of luma coding blocks. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to encode, in a parameter set, a first syntax element indicative of a luma coding tree block size of coding tree units (CTUs) to which the parameter set is applicable minus 5, encode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and encode the luma coding blocks to which the parameter set is applicable in accordance with the first syntax element and the second syntax element in the parameter set.

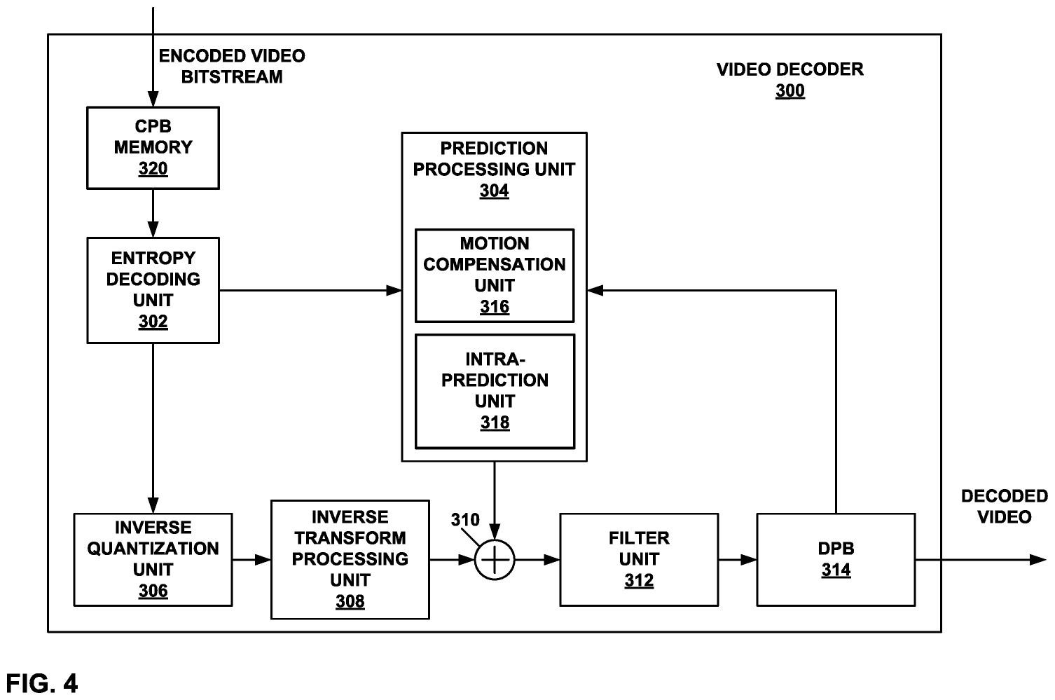

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of JEM, VVC, and HEVC. However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements, such as syntax elements indicative of a luma coding tree block size and indicative of a minimum coding block size of luma coding blocks. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

Video decoder 300 represents an example of a device configured to decode video data including a memory configured to store video data, and one or more processing units implemented in circuitry and configured to decode, in a parameter set, a first syntax element indicative of a luma coding tree block size of coding tree units (CTUs) to which the parameter set is applicable minus 5, decode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive, and decode the luma coding blocks to which the parameter set is applicable in accordance with the first syntax element and the second syntax element in the parameter set.

Signaling techniques for maximum and minimum block sizes of coding unit, transform units, and subpictures are herein disclosed. The signaling techniques of this disclosure may be applied to the Versatile Video Coding (VVC) standard and the other future video coding standards.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions. In addition, a new video coding standard, namely High Efficiency Video Coding (HEVC) or ITU-T H.265, including its range and screen content coding extensions, 3D video coding (3D-HEVC) and multiview extensions (MV-HEVC) and scalable extension (SHVC), has recently been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

In 2016, MPEG and ITU-T VCEG formed a Joint Exploration Video Team (JVET) to explore and develop new video coding tools for the next generation of video coding standard, VVC. VVC Draft 6 can be downloaded in JVET-02001. The reference software is called VVC Test Model (VTM). The sections in VVC Draft 6 that may be improved in this disclosure are shown in below in Table 1. Video encoder 200 may generate the parameters listed below and video decoder 300 may decode the parameters to determine how to decode corresponding video data.

TABLE 1

Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |
| sps_max_luma_transform_size_64_flag | u(1) |
| ... | |
| sps_transform_skip_enabled_flag | u(1) |
| ... | |

Section 7.4.3.3 in VVC Draft 6 version 14:
log2_ctu_size_minus5 plus 5 specifies the luma coding tree block size of

each CTU. It is a requirement of bitstream conformance that the value of
log2_ctu_size_minus5 be less than or equal to 2.

log2_min_luma_coding_block_size_minus2 plus 2 specifies the minimum

luma coding block size.

The variables CtbLog2SizeY, CtbSizeY, MinCbLog2SizeY, MinCbSizeY,

IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |
| IbcBufWidthY = 128 * 128 / CtbSizeY | (7-19) |
| IbcBufWidthC = IbcBufWidthY / SubWidthC | (7-20) |
| VSize = Min( 64, CtbSizeY ) | (7-21) |

The variables CtbWidthC and CtbHeightC, which specify the width and

height, respectively, of the array for each chroma CTB, are derived as follows:
- If chroma_format_idc is equal to 0 (monochrome) or separate_colour_plane_flag is equal to 1,
CtbWidthC and CtbHeightC are both equal to 0.
- Otherwise, CtbWidthC and CtbHeightC are derived as follows:

| | |
|---|---|
| CtbWidthC = CtbSizeY / SubWidthC | (7-22) |
| CtbHeightC = CtbSizeY / SubHeightC | (7-23) |

For log2BlockWidth ranging from 0 to 4 and for log2BlockHeight ranging

from 0 to 4, inclusive, the up-right diagonal and raster scan order array initialization
process as specified in clause 6.5.2 is invoked with 1 << log2BlockWidth and
1 << log2BlockHeight as inputs, and the output is assigned to
DiagScanOrder[ log2BlockWidth ][ log2BlockHeight ] and
Raster2DiagScanPos[ log2BlockWidth ][ log2BlockHeight ].

For log2BlockWidth ranging from 0 to 6 and for log2BlockHeight ranging

from 0 to 6, inclusive, the horizontal and vertical traverse scan order array
initialization process as specified in clause 6.5.3 is invoked with
1 << log2BlockWidth and 1 << log2BlockHeight as inputs, and the output is
assigned to HorTravScanOrder[ log2BlockWidth ][ log2BlockHeight ] and
VerTravScanOrder[ log2BlockWidth ][ log2BlockHeight ].

sps_max_luma_transform_size_64_flag equal to 1 specifies that the

maximum transform size in luma samples is equal to 64.
sps_max_luma_transform_size_64_flag equal to 0 specifies that the maximum
transform size in luma samples is equal to 32.

When CtbSizeY is less than 64, the value of

sps_max_luma_transform_size_64_flag shall be equal to 0.

The variables MinTbLog2SizeY, MaxTbLog2SizeY, MinTbSizeY, and

MaxTbSizeY are derived as follows:

| | |
|---|---|
| MinTbLog2SizeY = 2 | (7-27) |
| MaxTbLog2SizeY = sps_max_luma_transform_size_64_flag ? 6 : 5 | (7-28) |
| MinTbSizeY = 1 << MinTbLog2SizeY | (7-29) |
| MaxTbSizeY = 1 << MaxTbLog2SizeY | (7-30) |

sps_transform_skip_enabled_flag equa to 1 specifies that

transform_skip_flag may be present in the transform unit syntax.
sps_transform_skip_enabled_flag equal to 0 specifies that transform_skip_flag is not
present in the transform unit syntax

Section 7.3.2.4 in VVC Draft 6 version 14:

| | Descriptor |
|---|---|
| pic_parameter_set_rbsp( ) { | |
| ... | |
| if( sps_transform_skip_enabled_flag ) | |
| log2_transform_skip_max_size_minus2 | ue(v) |
| ... | |

Section 7.4.3.4 in VVC Draft 6 version 14:
log2_transform_skip_max_size_minus2 specifies the maximum block size

used for transform skip, and shall be in the range of 0 to 3.

When not present, the value of log2_transform_skip_max_size_minus2 is

inferred to be equal to 0.

The variable MaxTsSize is set equal to 1 <<

( log2_transform_skip_max_size_minus2 + 2 ).

VVC Draft 6 does not define the relationship between the maximum coding block size and the minimum coding block size. Different techniques are disclosed to address this issue and other related issues.

There are several example changes to improve the signaling in a sequence parameter set (SPS), a picture parameter set (PPS) and/or a slice header. At least one example change below or a combination of at least two example changes below may be applied to VVC Draft 6. The example changes are set forth below.

A minimum coding block size should be smaller than or equal to a coding block size. For example, MinCbLog2SizeY should be smaller than or equal to CtbLog2SizeY. However, in VVC Draft 6, a video coder may set MinCbLog2SizeY larger than CtbLog2SizeY, which may lead to issues, such as faulty coding. In this example, a restriction may be added to the VVC specification that MinCbLog2SizeY be smaller than or equal to CtbLog2SizeY. In other words, the VVC specification should require that MinCbLog2SizeY is smaller than or equal to CtbLog2SizeY. Video encoder 200 may restrict MinCbLog2SizeY to be smaller than or equal to CtbLog2SizeY and video decoder 300 may decode (e.g., parse) these syntax elements or other syntax elements to determine how to decode corresponding video data. Different techniques that may be used to accomplish this restriction are set forth herein.

Additionally, in Chuang, et al. “Interaction between dual tree and minimum CU size” Joint Video Experts Team (JVET) of ITU-T SG 16 WP 3 and ISO/IEC JTC 1/SC 29/WG 11, 16th Meeting: Geneva, CH, 1-11 Oct. 2019, JVET-P0578-v1 (hereinafter “JVET-P0578”) qtbtt dual tree intra flag equal to 1 and MinCbSizeY equal to 128 may occur at the same time. When this occurs, a 128×128-luma/2×64×64-chroma coding tree unit (CTU) will be partitioned to four 64×64-luma/2×32×32-chroma child nodes with inferred quadtree (QT) split, which is contrary to the MinCbSizeY setting.

In one example, a conformance requirement may be added to restrict MinCbLog2SizeY to be smaller than or equal to CtbLog2SizeY. In other words, in order to conform to the applicable standard, such as VVC, MinCbLog2SizeY must be smaller than or equal to CtbLog2SizeY. Video encoder 200 may restrict MinCbLog2SizeY to be smaller than or equal to CtbLog2SizeY and video decoder 300 may decode (e.g., parse) these parameters to determine how to decode corresponding video data. The syntax changes to VVC Draft 6 for this example are as described in Table 2 between <ADD> and </ADD>.

TABLE 2
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |
| sps_max_luma_transform_size_64_flag | u(1) |
| ... | |
| sps_transform_skip_enabled_flag | u(1) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of
log2_ctu_size_minus5 be less than or equal to 2.
log2_min_luma_coding_block_size_minus2 plus 2 specifies the minimum luma coding
block size.
The variables CtbLog2SizeY, CtbSizeY, MinCbLog2SizeY, MinCbSizeY, IbcBufWidthY,
IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |
| IbcBufWidthY = 128 * 128 / CtbSizeY | (7-19) |
| IbcBufWidthC = IbcBufWidthY / SubWidthC | (7-20) |
| VSize = Min( 64, CtbSizeY ) | (7-21) |

<ADD> It is a requirement of bitstream conformance that the value of MinCbLog2SizeY
shall be smaller than or equal to CtbLog2SizeY. </ADD>

In another example, a range of values may be added to log2_min_luma_coding_block_size_minus2 to restrict MinCbLog2SizeY to be smaller than or equal to CtbLog2SizeY. For example, video encoder 200 may restrict a value of log2_min_luma_coding_block_size_minus2 to be in the range of zero to log2_ctu_size_minus5+three, inclusive, and video decoder 300 may decode (e.g., parse) these syntax elements to determine how to decode corresponding video data. For example, video encoder 200 or video decoder 300 may code, in a parameter set, a first syntax element indicative of a luma coding tree block size of coding tree units (CTUs) to which the parameter set is applicable minus 5. Video encoder 200 or video decoder 300 may also code, in the parameter set, a second syntax element indicative of a minimum luma coding block size minus 2 of luma coding blocks to which the parameter set is applicable, wherein a value of the second syntax element is in a range of 0 to a value based on the first syntax element, inclusive. Video encoder 200 or video decoder 300 may code the luma coding blocks to which the parameter set is applicable in accordance with the first syntax element and the second syntax element in the parameter set. In some examples, video encoder 200 may restrict the value of the second syntax element to be in the range of 0 to the value based on the first syntax element, inclusive. In this example, the value based on the first syntax element is a value of the first syntax element plus 3. For example, the first syntax element may be log2_ctu_size_minus5 and the second syntax element may be log2_min_luma_coding_block_size_minus2. The syntax changes to VVC Draft 6 for this example are as described in Table 3 between <ADD> and </ADD>.

TABLE 3
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |
| sps_max_luma_transform_size_64_flag | u(1) |
| ... | |
| sps_transform_skip_enabled_flag | u(1) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of
log2_ctu_size_minus5 be less than or equal to 2.
log2_min_luma_coding_block_size_minus2 plus 2 specifies the minimum luma
coding block size. <ADD> The value of log2_min_luma_coding_block_size_minus2
shall be in the range of 0 to log2_ctu_size_minus5 + 3, inclusive. </ADD>
The variables CtbLog2SizeY, CtbSizeY, MinCbLog2SizeY, MinCbSizeY, IbcBufWidthY,
IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |
| IbcBufWidthY = 128 * 128 / CtbSizeY | (7-19) |
| IbcBufWidthC = IbcBufWidthY / SubWidthC | (7-20) |
| VSize = Min( 64, CtbSizeY ) | (7-21) |

In another example, log2_min_luma_coding_block_size_minus2 is replaced with log2_diff_max_min_luma_coding_block_size to signal the difference between a maximum and a minimum luma coding block size, and the base 2 logarithm of the minimum luma coding block size may be derived by subtracting log2_diff_max_min_luma_coding_block_size from log2_ctu_size_minus5. Video encoder 200 may restrict that MinCbLog2SizeY is smaller than or equal to CtbLog2SizeY. For example, video encoder 200 may use log2_diff_max_min_luma_coding_block_size to signal the difference between a maximum and a minimum luma coding block size and video decoder 300 may derive the base 2 logarithm of the minimum luma coding block size by subtracting log2_diff_max_min_luma_coding_block_size from log2_ctu_size_minus5. The syntax changes to VVC Draft 6 for this example are as described in Table 4 between <ADD> and </ADD> for additions and between <DELETE> and </DELETE> for deletions.

TABLE 4
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| <DELETE> log2_min_luma_coding_block_size_minus2 | ue(v) |
| | </DELETE> |
| <ADD> log2_diff_max_min_luma_coding_block_size | ue(v) |
| | </ADD> |
| ... | |
| sps_max_luma_transform_size_64_flag | u(1) |
| ... | |
| sps_transform_skip_enabled_flag | u(1) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of
log2_ctu_size_minus5 be less than or equal to 2.
<DELETE> log2_min_luma_coding_block_size_minus2 plus 2 specifies the
lminimum uma coding block size. </DELETE>
<ADD> log2_diff_max_min_luma_coding_block_size specifies the difference
between the maximum and minimum luma coding block size. </ADD>
The variables CtbLog2SizeY, CtbSizeY, MinCbLog2SizeY, MinCbSizeY,
IbcBufWidthY, IbcBufWidthC and Vsize are derived as follows:

| CtbLog2SizeY = log2_ctu_size_minus5 + 5 | (7-15) |
|---|---|
| CtbSizeY = 1 << CtbLog2SizeY | (7-16) |
| <DELETE> MinCbLog2SizeY = | (7-17) |
| log2_min_luma_coding_block_size_minus2 + 2 </DELETE> | |
| <ADD> MinCbLog2SizeY = CtbLog2SizeY − | |
| log2_diff_max_min_luma_coding_block_size (7-17) </ADD> | |
| MinCbSizeY = 1 << MinCbLog2SizeY | (7-18) |
| IbcBufWidthY = 128 * 128 / CtbSizeY | (7-19) |
| IbcBufWidthC = IbcBufWidthY / SubWidthC | (7-20) |
| VSize = Min( 64, CtbSizeY ) | (7-21) |

In another example, a numerical range of 0 to min(4, log2_ctu_size_minus5+3), inclusive, is added into the semantics of log2_min_luma_coding_block_size_minus2. This example may restrict MinCbLog2SizeY to be smaller than or equal to CtbLog2SizeY. This example may also restrict MinCbLog2SizeY is smaller than or equal to 64, which addresses the issue mentioned above with respect to JVET-P0578. Video encoder 200 may restrict a value of log2_min_luma_coding_block_size_minus2 to be in the range of 0 to min(4, log2_ctu_size_minus5+3), inclusive and video decoder 300 may decode (e.g., parse) these syntax elements to determine how to decode corresponding video data. For example, video encoder 200 or video decoder 300 may code, in a parameter set, a first syntax element indicative of a luma coding tree block size of coding tree units (CTUs) to which the parameter set is applicable minus 5. Video encoder 200 or video decoder 300 may also code, in the parameter set, a second syntax element indicative of a minimum luma coding block size minus 2 of luma coding blocks to which the parameter set is applicable, wherein a value of the second syntax element is in a range of 0 to a value based on the first syntax element, inclusive. Video encoder 200 or video decoder 300 may code the luma coding blocks to which the parameter set is applicable in accordance with the first syntax element and the second syntax element in the parameter set. In some examples, video encoder 200 may restrict the value of the second syntax element to be in the range of 0 to the value based on the first syntax element, inclusive. In this example, the value based on the first syntax element is a a minimum of (i) 4 and (ii) a value of the first syntax element plus 3. For example, the first syntax element may be log2_ctu_size_minus5 and the second syntax element may be log2_min_luma_coding_block_size_minus2. The syntax changes to VVC Draft 6 are as described in Table 5 between <ADD> and </ADD>.

TABLE 5
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of log2_ctu_size_minus5
be less than or equal to 2.
log2_min_luma_coding_block_size_minus2 plus 2 specifies the minimum luma
coding block size. <ADD>The value of
log2_min_luma_coding_block_size_minus2 shall be in the range of 0 to min(4,
log2_ctu_size_minus5 + 3), inclusive.</ADD>
The variables CtbLog2SizeY, CtbSizeY, MinCbLog2SizeY, MinCbSizeY,
IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |

In another example, solution 2.2 in Chang, et al. “AHG17: On log2_min_luma_coding_block_size_minus2” Joint Video Experts Team (WET) of ITU-T SG 16 WP 3 and ISO/IEC JTC 1/SC 29/WG 11, 16th Meeting: Geneva, CH, 1-11 Oct. 2019, JVET-P0429 (hereinafter “JVET-P0429”) and method 3 in JVET-P0578 are combined. For example, video encoder 200 may restrict a value of log2_min_luma_coding_block_size_minus2 shall be in the range of 0 to min(qtbtt dual tree intra flag ? 4 : 5, log2_ctu_size_minus5+3), inclusive and video decoder 300 may decode (e.g., parse) these syntax elements to determine how to decode corresponding video data.

The syntax changes to VVC Draft 6 are as described in the Table 6 between <CHANGE> and </CHANGE>.

TABLE 6
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of log2_ctu_size_minus5
be less than or equal to 2.
log2_min_luma_coding_block_size_minus2 plus 2 specifies the minimum luma
coding block size. <CHANGE>The value of
log2_min_luma_coding_block_size_minus2 shall be in the range of 0 to
min(qtbtt_dual_tree_intra_flag ? 4 : 5, log2_ctu_size_minus5 + 3),
inclusive.</CHANGE>
The variables CtbLog2SizeY, CtbSizeY, MinCbLog2SizeY, MinCbSizeY,
IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |

Signaling of transform size and transform skip is now discussed. The transform skip scheme is intended to be enabled only if cbWidth<=32 and cbHeight<=32. However, the transform skip scheme can be enabled by setting sps_transform_skip_enabled_flag equal to 1 even if MinCbSizeY is larger than 32. To solve this issue, a restriction may be set to the signaling of sps_transform_skip_enabled_flag.

In one example, a conformance requirement is added to enforce sps_transform_skip_enabled_flag to be zero if MinCbLog2SizeY is larger than 5 (e.g., the minimum coding block height is larger than 32). In other words, in order to conform to the applicable standard, such as VVC, sps_transform_skip_enabled_flag must be zero if MinCbLog2SizeY is larger than 5. Video encoder 200 may set sps_transform_skip_enabled_flag to be zero if MinCbLog2SizeY is larger than 5 and video decoder 300 may decode (e.g., parse) these syntax elements to determine how to decode the corresponding video data. The syntax changes to VVC Draft 6 for this example are as described in Table 7 between <ADD> and </ADD>.

TABLE 7
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |
| sps_max_luma_transform_size_64_flag | u(1) |
| ... | |
| sps_transform_skip_enabled_flag | u(1) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of
log2_ctu_size_minus5 be less than or equal to 2.
log2_min_luma_coding_block_size_minus2 plus 2 specifies the minimum luma coding
block size.
The variables CtbLog2SizeY, CtbSizeY, MinCbLog2SizeY, MinCbSizeY,
IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |

sps_max_luma_transform_size_64_flag equal to 1 specifies that the maximum transform
size in luma samples is equal to 64. sps_max_luma_transform_size_64_flag equal to 0
specifies that the maximum transform size in luma samples is equal to 32.
When CtbSizeY is less than 64, the value of sps_max_luma_transform_size_64_flag
shall be equal to 0.
The variables MinTbLog2SizeY, MaxTbLog2SizeY, MinTbSizeY, and MaxTbSizeY are
derived as follows:

| | |
|---|---|
| MinTbLog2SizeY = 2 | (7-27) |
| MaxTbLog2SizeY = sps_max_luma_transform_size_64_flag ? 6 : 5 | (7-28) |
| MinTbSizeY = 1 << MinTbLog2SizeY | (7-29) |
| MaxTbSizeY = 1 << MaxTbLog2SizeY | (7-30) |

sps_transform_skip_enabled_flag equa to 1 specifies that transform skip flag may be
present in the transform unit syntax. sps_transform_skip_enabled_flag equal to 0 specifies
that transform skip flag is not present in the transform unit syntax. <ADD> It is a
requirement of bitstream conformance that the value of sps_transform_skip_enabled_flag
shall be zero if MinCbLog2SizeY is larger than 5. </ADD>
Section 7.3.2.4 in VVC Draft 6 version 14:

| | Descriptor |
|---|---|
| pic_parameter_set_rbsp( ) { | |
| ... | |
| if( sps_transform_skip_enabled_flag ) | |
| log2_transform_skip_max_size_minus2 | ue(v) |
| ... | |

Section 7.4.3.4 in VVC Draft 6 version 14:
log2_transform_skip_max_size_minus2 specifies the maximum block size used for
transform skip, and shall be in the range of 0 to 3.
When not present, the value of log2_transform_skip_max_size_minus2 is
tinferred to be equal o 0.
The variable MaxTsSize is set equal to 1 <<
( log2_transform_skip_max_size_minus2 + 2 ).

In another example, sps_transform_skip_enabled_flag is inferred to be zero if MinCbLog2SizeY is larger than 5. For example, video decoder 300 may infer sps_transform_skip_enabled_flag to be zero if MinCbLog2SizeY is larger than 5. In another example, video decoder 300 may infer sps_transform_skip_enabled_flag to be zero if it is not present. The syntax changes to VVC Draft 6 for this example are as described in Table 8 between <ADD> and </ADD>.

TABLE 8
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |
| sps_max_luma_transform_size_64_flag | u(1) |
| ... | |
| <ADD> if( MinCbLog2SizeY <= 5 ) </ADD> | |
| sps_transform_skip_enabled_flag | u(1) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of
log2_ctu_size_minus5 be less than or equal to 2.
log2_min_luma_coding_block_size_minus2 plus 2 specifies the minimum luma coding
block size.
The variables CtbLog2SizeY, CtbSizeY, MinCbLog2SizeY, MinCbSizeY,
IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |

sps_max_luma_transform_size_64_flag equal to 1 specifies that the maximum transform
size in luma samples is equal to 64. sps_max_luma_transform_size_64_flag equal to 0
specifies that the maximum transform size in luma samples is equal to 32.
When CtbSizeY is less than 64, the value of sps_max_luma_transform_size_64_flag
shall be equal to 0.
The variables MinTbLog2SizeY, MaxTbLog2SizeY, MinTbSizeY, and MaxTbSizeY are
derived as follows:

| | |
|---|---|
| MinTbLog2SizeY = 2 | (7-27) |
| MaxTbLog2SizeY = sps_max_luma_transform_size_64_flag ? 6 : 5 | (7-28) |
| MinTbSizeY = 1 << MinTbLog2SizeY | (7-29) |
| MaxTbSizeY = 1 << MaxTbLog2SizeY | (7-30) |

sps_transform_skip_enabled_flag equa to 1 specifies that transform_skip_flag may be
present in the transform unit syntax, sps_transform_skip_enabled_flag equal to 0 specifies
that transform_skip_flag is not present in the transform unit syntax. <ADD> If not present,
the value of sps_transform_skip_enabled_flag shall be equal to 0. </ADD>
Section 7.3.2.4 in VVC Draft 6 version 14:

| | Descriptor |
|---|---|
| pic_parameter_set_rbsp( ) { | |
| ... | |
| if( sps_transform_skip_enabled_flag ) | |
| log2_transform_skip_max_size_minus2 | ue(v) |
| ... | |

Section 7.4.3.4 in VVC Draft 6 version 14:
log2_transform_skip_max_size_minus2 specifies the maximum block size used for
transform skip, and shall be in the range of 0 to 3.
When not present, the value of log2_transform_skip_max_size_minus2 is
inferred to be equal to 0.
The variable MaxTsSize is set equal to 1 <<
( log2_transform_skip_max_size_minus2 + 2 ).

In another example, inferences to sps_max_transform_size_64_flag in VVC Draft 6 may be added based on CtbLog2SizeY and MinCbLog2SizeY to avoid coding flaws. Table 9 below shows the inferences required, where CtbLog2SizeY>=MinCbLog2SizeY. For example, video decoder 300 may infer sps_max_transform_size_64_flag to be the value indicated in Table 9 based on CtbLog2SizeY and/or MinCbLog2SizeY.

TABLE 9

| | | | | | | |
|---|---|---|---|---|---|---|
| CtbLog2SizeY | 7 | 7 | 6 | 5 | 5 | 5 |
| MinCbLog2SizeY | 7 | 6 | 6 | 4 | 3 | 2 |
| Inference of | 1 | 1 | 1 | 0 | 0 | 0 |
| sps_max_transform_size_64_flag | | | | | | |

Method 2 of Sarwer, et al. “CE8-related: Alignment of maximum transform-skip size with maximum transform block size” Joint Video Experts Team (WET) of ITU-T SG 16 WP 3 and ISO/IEC JTC 1/SC 29/WG 11, 16th Meeting: Geneva, CH, 1-11 Oct. 2019, JVET-P0486-v3 (hereinafter “JVET-P0486”) incorporates a new syntax element sps_max_transform_skip_size_64_flag (indicating whether the maximum transform skip size is 32 or 64) signaled in the same manner as sps_max_transform_size_64_flag. In another example, the same inferences to sps_max_transform_skip_size_64_flag in VVC Draft 6 may be added based on MinCbLog2SizeY to avoid issues. Table 10 below shows the inferences, where CtbLog2SizeY>=MinCbLog2SizeY. For example, video decoder 300 may infer sps_max_transform_skip_size_64_flag to be the value indicated in Table 10 based on CtbLog2SizeY and/or MinCbLog2SizeY.

TABLE 10

| | | | | | | |
|---|---|---|---|---|---|---|
| CtbLog2SizeY | 7 | 7 | 6 | 5 | 5 | 5 |
| MinCbLog2SizeY | 7 | 6 | 6 | 4 | 3 | 2 |
| Inference of | 1 | 1 | 1 | 0 | 0 | 0 |
| sps_max_transform_skip_size_64_flag | | | | | | |

In another example, sps_max_transform_size_64_flag is signaled only when CtbLog2SizeY>5 and MinCbLog2SizeY<6. Therefore, if CtbLog2SizeY is equal to 5, sps_max_transform_size_64_flag is inferred to be 0 and if MinCbLog2SizeY is larger than or equal to 6, sps_max_transform_size_64_flag is inferred to be 1. The syntax changes to VVC Draft 6 are as described in Table 11 below with additions between <ADD> and </ADD> and deletions between <DELETE> and </DELETE>.

TABLE 11
Section 7.3.2.3 in VVC Draft 6 version 14:

| | Descriptor |
|---|---|
| seq_parameter_set_rbsp( ) { | |
| ... | |
| log2_ctu_size_minus5 | u(2) |
| log2_min_luma_coding_block_size_minus2 | ue(v) |
| ... | |
| <ADD> If( CtbLog2SizeY > 5 && MinCbLog2SizeY < 6 )</ADD> | |
| sps_max_luma_transform_size_64_flag | u(1) |
| ... | |

Section 7.4.3.3 in VVC Draft 6 version 14:
log2_ctu_size_minus5 plus 5 specifies the luma coding tree block size of each CTU.
It is a requirement of bitstream conformance that the value of log2_ctu_size_minus5
be less than or equal to 2.
log2_min_luma_coding_block_size_minus2 plus 2 specifies the minimum luma
coding block size.
The variables CtbLog2SizeY, CtbSizeY, MinCbLog2SizeY, MinCbSizeY,
IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |

sps_max_luma_transform_size_64_flag equal to 1 specifies that the maximum
transform size in luma samples is equal to 64.
sps_max_luma_transform_size_64_flag equal to 0 specifies that the maximum
transform size in luma samples is equal to 32. <ADD>If not present and
CtbLog2SizeY > 5, the value of sps_max_luma_transform_size_64_flag shall be
equal to 0. If not present and MinCbLog2SizeY < 6, the value of
sps_max_luma_transform_size_64_flag shall be equal to 1 </ADD>
<DELETE>When CtbSizeY is less than 64, the value of
sps_max_luma_transform_size_64_flag shall be equal to 0.</DELETE>
The variables MinTbLog2SizeY, MaxTbLog2SizeY, MinTbSizeY, and MaxTbSizeY
are derived as follows:

| | |
|---|---|
| MinTbLog2SizeY = 2 | (7-27) |
| MaxTbLog2SizeY = sps_max_luma_transform_size_64_flag ? 6 : 5 | (7-28) |
| MinTbSizeY = 1 << MinTbLog2SizeY | (7-29) |
| MaxTbSizeY = 1 << MaxTbLog2SizeY | (7-30) |

In another example, sps_max_transform_skip_size_64_flag may only be signaled when MinCbLog2SizeY<6, sps_max_luma_transform_size_64_flag=1 and sps_transform_skip_enabled_flag is equal to 1. Therefore, if MinCbLog2SizeY is larger than or equal to 6, sps_max_transform_skip_size_64_flag is inferred to be 1. For example, if MinCbLog2SizeY is larger than or equal to 6, video decoder 300 may infer sps_max_transform_skip_size_64_flag to be 1.

The syntax changes to 7VET-P0486 method 2 are as described in Table 12 below with changes are marked with additions between <ADD> and </ADD> and deletions between <DELETE> and </DELETE>.

TABLE 12
Section 7.3.2.3 in VVC Draft 6 version 14:

| | | Descriptor |
|---|---|---|
| seq_parameter_set_rbsp( ) { | | |
| ... | | |
| log2_ctu_size_minus5 | | u(2) |
| log2_min_luma_coding_block_size_minus2 | | ue(v) |
| ... | | |
| <ADD> if( CtbLog2SizeY > 5 && MinCbLog2SizeY < 6 )</ADD> | | |
| sps_max_luma_transform_size_64_flag | | u(1) |
| ... | | |
| sps_transform_skip_enabled_flag | | u(1) |
| <DELELTE> if( sps_max_luma_transform_size_64_flag ) </DELETE> | | |
| <ADD> if( MinCbLog2SizeY < 6 && sps_max_luma_transform_size_64_flag | | |
| && | | |
| sps_transform_skip_enabled_flag ) </ADD> | | |
| | sps_max_transform_skip_size_64_flag | u(1) |

...
Section 7.4.3.3 in VVC Draft 6 version 14:
log2_ctu_size_minus5 plus 5 specifies the luma coding tree block size of each CTU.
It is a requirement of bitstream conformance that the value of log2_ctu_size_minus5
be less than or equal to 2.
Log2_min_luma_coding_block_size_minus2 plus 2 specifies the minimum luma
coding block size.
The variables CtbLog2SizeY, CtbSizeY, MinCbLog2SizeY, MinCbSizeY,
IbcBufWidthY, IbcBufWidthC and Vsize are derived as follows:

| | |
|---|---|
| CtbLog2SizeY = log2_ctu_size_minus5 + 5 | (7-15) |
| CtbSizeY = 1 << CtbLog2SizeY | (7-16) |
| MinCbLog2SizeY = log2_min_luma_coding_block_size_minus2 + 2 | (7-17) |
| MinCbSizeY = 1 << MinCbLog2SizeY | (7-18) |

sps_max_luma_transform_size_64_flag equal to 1 specifies that the maximum
transform size in luma samples is equal to 64.
sps_max_luma_transform_size_64_flag equal to 0 specifies that the maximum
transform size in luma samples is equal to 32. <ADD>If not present and
CtbLog2SizeY > 5, the value of sps_max_luma_transform_size_64_flag shall be
equal to 0. If not present and MinCbLog2SizeY < 6, the value of
sps_max_luma_transform_size_64_flag shall be equal to 1.</ADD>
<DELETE>When CtbSizeY is less than 64, the value of
sps_max_luma_transform_size_64_flag shall be equal to 0.</DELETE>
The variables MinTbLog2SizeY, MaxTbLog2SizeY, MinTbSizeY, and MaxTbSizeY
are derived as follows:

| | |
|---|---|
| MinTbLog2SizeY = 2 | (7-27) |
| MaxTbLog2SizeY = sps_max_luma_transform_size_64_flag ? 6 : 5 | (7-28) |
| MinTbSizeY = 1 << MinTbLog2SizeY | (7-29) |
| MaxTbSizeY = 1 << MaxTbLog2SizeY | (7-30) |

sps_transform_skip_enabled_flag equal to 1 specifies that transform skip flag may
be present in the transform unit syntax. sps_transform_skip_enabled_flag equal to 0
specifies that transform skip flag is not present in the transform unit syntax
sps_max_transform_skip_size_64_flag equal to 0 specifies that the maximum block
size used for transform skip is 32. sps_max_transform_skip_size_64_flag equal to 1
specifies that the maximum block size used for transform skip is 64.
When not present, the value of sps_max_transform_skip_size_64_flag is inferred to
be equal to 0.
The maximum value of width or height of the TS mode is computed as follows:

MaxTsSize = sps_max_transform_skip_size_64_? 64 : 32

Subpicture signaling is now discussed. In some examples, according to the techniques of this disclosure, video encoder 200 may define and/or signal a maximum number of subpictures in an SPS and video encoder 200 may signal a number of subpictures in a PPS. Video decoder 300 may parse syntax elements to determine a maximum number of subpictures and a number of subpictures.

In one example, the number of subpictures signaled in a PPS may be restricted by a maximum number of subpictures in an SPS to avoid very large values signaled in the PPS even if the number of subpictures is smaller than or equal to the number of slices in a picture.

In one example, the value of the maximum number of subpictures in the SPS and the value of the number of subpictures in the PPS is at least 2. In this case, the syntax elements may be max_subpics_minus2 and num_subpics_minus2, respectively. The number of subpictures may be enabled meaningfully only when there are at least 2 or more subpictures.

In one example, a subpicture enabled flag may be signaled only when rect_lice_flag is equal to 1 and num_slices_inpic_minus1 is larger than 0. A subpicture may be a rectangular shape. If the number of slices in a picture is equal to 1, the picture is not to be split into smaller subpictures. num_slices_inpic_minus1, plus 1, specifies the number of slices in each picture referring to the PPS. For example, video encoder 200 may only signal a subpicture enabled flag when rect_lice_flag is equal to 1 and num_slices_inpic_minus1 is larger than 0.

It is noted that there are proposals to use single_slice_per_subpic_flag to specify if each subpicture in each picture includes one and only one rectangular slice. However, in one example, single_slice_per_subpic_flag may be inferred to be equal to 1 if the number of slices in a picture is equal to 1 or 2. If the number of slices in the picture is equal to 2 and the number of subpictures is equal to 1, this implies that the picture is partitioned into two subpictures, each of which includes only one slice. For example, video decoder 300 may infer single_slice_per_subpic_flag to be equal to 1 if the number of slices in a picture is equal to 1 or 2.

In another example, single_slice_per_subpic_flag may be zero if num_slices_inpic_minus1+1>max_subpics_minus2+2. This inference is based on the fact that at least one subpicture includes more than 1 slice when the number of slices is larger than the maximum number of subpictures. For example, video decoder 300 may infer single_slice_per_subpic_flag to be zero if num_slices_inpic_minus1+1>max_subpics_minus2+2.

The described syntax changes above may be applied to any standards contributions that relate to subpicture signaling. For convenience, this disclosure adds the proposed syntax changes to Hannuksela et al., “AHG12: Signaling of subpicture IDs and layout,” Joint Video Experts Team (WET) of ITU-T SG 16 WP 3 and ISO/IEC JTC 1/SC 29/WG 11, 16th Meeting: Geneva, CH, 1-11 Oct. 2019, document JVET P0126 (hereinafter, JVET-P0126″) whose design of subpicture ID is based on slice indexes.

In one example, syntax changes to “JVET-P0126-v1 spec BasedOnSlice.docx” with the signaling of the maximum number of subpictures in the SPS are presented in Table 13 below. Additions are marked between <ADD> and </ADD> and deletions are marked between <DELETE> and </DELETE>.

TABLE 13
7.3.2.3 SPS syntax in the document file “JVET-P0126-v1_spec_BasedOnSlice.docx”

| | Descriptor |
|---|---|
| seq_parameter_set_rbsp( ) { | |
| ... | |
| <ADD> max_subpics_minus2</ADD> | <ADD>u(8)</ADD> |
| ... | |

7.3.2.3 SPS syntax in the document file “JVET-P0126-v1_spec_BasedOnSlice.docx”
<ADD>max_subpics_minus2 plus 2 specifies the maximum number of subpictures
that may be present in the CVS. max_subpics_minus2 shall be in the range of 0 to
253. The values of 254 and 255 are reserved for future use by ITU-T |
ISO/IEC.</ADD>
7.3.2.4 PPS syntax in the document file “JVET-P0126-v1_spec_BasedOnSlice.docx”

| | | Descriptor |
|---|---|---|
| pic_parameter_set_rbsp( ) { | | |
| ... | | |
| if( rect_slice_flag <ADD>&& num_slices_in_pic_minus1 > 0</ADD> ) { | | |
| subpics_present_flag | | u(1) |
| if( subpics_present_flag ) { | | |
| <DELETE> if( num_slices_in_pic_minus1 > 0 ) </DELETE> | | |
| <ADD> if( num_slices_in_pic_minus1 > 1 ) </ADD> | | |
| | single_slice_per_subpic_flag | u(1) |
| | if( !single_slice_per_subpic_flag ) | |
| <DELETE> num_subpics_minus1 </DELETE> | | ue(v) |
| <ADD> num_subpics_minus2 </ADD> | | |
| <DELETE> if( num_subpics_minus1 > 0 ) </DELETE> | | |
| | if( !single_slice_per_subpic_flag ) { | |
| | bottom_right_slice_idx_length_minus1 | ue(v) |
| | for( i = 0; i < num_subpics_minus1; i++ ) { | |

| | |
|---|---|
| bottom_right_slice_idx_delta[ i ] | u(v) |
| if( i > 0 ) | |
| slice_idx_delta_sign_flag[ i ] | u(1) |

| | |
|---|---|
| } | |
| } | |
| for( i = 0; i <= num_subpics_minus1; i++ ) { | |
| subpic_treated_as_pic_flag[ i ] | u(1) |
| loop_filter_across_subpic_enabled_flag[ i ] | u(1) |
| } | |
| } | |
| subpic_ids_constant_in_clvs_flag | u(1) |
| subpic_id_len_minus1 | ue(v) |
| for( i = 0;i <= num_subpics_minus1; i++ ) | |
| pps_subpic_id[ i ] | u(v) |

```
    }
  }
  ...
7.4.3.4 PPS semantics in the document file “JVET-P0126-
v1_spec_BasedOnSlice.docx”
subpics_present_flag equal to 1 indicates that subpicture parameters are present in
the present in the PPS RBSP syntax. subpics_present_flag equal to 0 indicates that
subpicture parameters are not present in the present in the PPS RBSP syntax. When
not present, the value of subpics_present_flag is inferred to be equal to 0.
  NOTE - When a bitstream is the result of a subpicture based sub-bitstream extraction process wherein the
  input bitstream contains multiple subpictures per picture and during the extraction VCL NAL units may only
  be extracted or discarded but not changed, and the bitstream contains only a true subset of the subpictures of
  the input bitstream, the value of subpics_present_flag has to be equal to 1 in the RBSP of the PPSs in the
  bitstream, even when there is only one subpicture in each picture.
single_slice_per_subpic_flag equal to 1 specifies that each subpicture in each picture
referring to this PPS includes one rectangular slice. single_slice_per_subpic_flag
equal to 0 specifies that a subpicture in a picture referring to this PPS may include
more than one rectangular slice. When rect_slice_flag is equal to 1 and
num_slices_in_pic_minus1 is equal to <DELETE> 0 </DELETE> <ADD>or smaller
than 1 </ADD>, the value of single_slice_per_subpic_flag is inferred to be equal to 1.
<ADD>There is a requirement of bitstream conformance that
single_slice_per_subpic_flag shall be zero if num_slices_in_pic_minus1 + 1 >
max_subpics_minus2 + 2, i.e., num_slices_in_pic_minus1 > max_subpics_minus2 +
1.</ADD>
<DELETE> num_subpics_minus1 plus 1 specifies the number of subpictures in
each picture referring to the PPS. num_subpics_minus1 shall be in the range of 0 to
num_slices_in_pic_minus1, inclusive. When subpics_present_flag is equal to 0, the
value of num_subpics_minus1 is inferred to 0. When not present and
single_slice_per_subpic_flag is equal to 1, the value of num_subpics_minus1 is
inferred to be equal to num_slices_in_pic_minus1. The variable NumSubPics is
derived to be equal to num_subpics_minus1 + 1. </DELETE>
<ADD> num_subpics_minus2 plus 2 specifies the number of subpictures in each
picture referring to the PPS. num_subpics_minus2 shall be in the range of 0 to
min(num_slices_in_pic_minus1 − 1, max_subpics_minus2), inclusive. When
subpics_present_flag is equal to 0, the value of num_subpics_minus2 is inferred to −1.
When not present and single_slice_per_subpic_flag is equal to 1, the value of
num_subpics_minus2 is inferred to be equal to num_slices_in_pic_minus1 − 1. The
variable NumSubPics is derived to be equal to num_subpics_minus2 + 2. </ADD>
bottom_right_slice_idx_length_minus1 plus 1 specifies the number of bits used to
represent the syntax element bottom_right_slice_idx_delta[ i ]. The value of
bottom_right_slice_idx_length_minus1 shall be in the range of 0 to
Ceil( Log2( num_slices_in_pic_minus1 + 1 ) ) − 1, inclusive.
bottom_right_slice_idx_delta[ i ] when i is greater than 0 specifies the difference
between the slice index of the slice located at the bottom-right corner of the i-th
subpicture and the slice index of the bottom-right corner of the ( i − 1 )-th subpicture.
bottom_right_slice_idx_delta[ 0 ] specifies the slice index of the bottom right corner
of the 0-th subpicture. When single_slice_per_subpic_flag is equal to 1, the value of
bottom_right_slice_idx_delta[ 0 ] is inferred to be equal to 0 and the value of
bottom_right_slice_idx_delta[ i ] is inferred to be equal to 1 for the values of i greater
than 0. The value of the BottomRightSliceIdx[ num_subpics_minus1 ] is inferred to
be equal to num_slices_in_pic_minus1. The length of the
bottom_right_slice_idx_delta[ i ] syntax element is
bottom_right_slice_idx_length_minus1 + 1 bits.
slice_idx_delta_sign_flag[ i ] equal to 1 indicates a positive sign for
bottom_right_slice_idx_delta[ i ]. slice_idx_delta_sign_flag[ i ] equal to 0 indicates a
negative sign for bottom_right_brick_idx_delta[ i ]. <ADD>When
single_slice_per_subpic_flag is equal to 1, the value of slice_idx_delta_sign_flag[ i ]
is inferred to be equal to 1.</ADD>
The variables TopLeftSliceIdx[ i ], BottomRightSliceIdk[ i ], NumSlicesInSubpic[ i ],
SliceToSubpicMap[ j ], and SliceSubpicToPicIdx[ i ][ k ], which specify the slice
index of the slice located at the top left corner of the i-th subpicture, the slice index of
the slice located at the bottom right corner of the i-th subpicture, the number of slices
in the i-th subpicture, the subpicture index of the subpicture containing the j-th slice,
and the picture-level slice index of the k-th slice in the i-th subpicture, respectively,
are derived as follows:
```

```
if( single_slice_per_subpic_flag ) {
  TopLeftSliceIdx[ i ] = i
  BottomRightSliceIdx[ i ] = i
  NumSlicesInSubpic[ i ] = 1
  SliceToSubpicMap[ i ] = i
  SliceSubpicToPicIdx[ i ][ 0 ] = 0
} else {
  for( j = 0; i = = 0 && j <= num_slices_in_pic_minus1; j++ )
  SliceToSubpicMap[ j ] = −1
  NumSlicesInSubpic[ i ] = 0
if( i = = num_subpics_minus1 )
  BottomRightSliceIdx[ i ] = num_slices_in_pic_minus1
  else
  BottomRightSliceIdx[ i ] = i = = 0 ? bottom_right_slice_idx_delta[ i ] :
```

```
  ( BottomRightSliceIdx[ i − 1 ] + ( slice_idx_delta_sign_flag[ i ] ?
    bottom_right_slice_idx_delta[ i ] : −bottom_right_slice_idx_delta[ i ] ) )
```

| for( j = BottomRightSliceIdx[ i ]; j >= 0; j−− ) { | |
|---|---|
| if( SliceColBd[ j ] + SliceWidth[ j ] <= | |
| SliceColBd[ BottomRightSliceIdx[ i ] ] + SliceWidth[BottomRightSliceIdx[ i ] ] && | (7-43) |

SliceRowBd[ j ] + SliceHeight[ j ] <=

SliceRowBd[ BottomRightSliceIdx[ i ] ] + SliceHeight[BottomRightSliceIdx[ i ] ] &&

SliceToSubpicMap[ j ] == −1 ) {
TopLeftSliceIdx[ i ] = j
NumSlicesInSubpic[ i ]++
SliceToSubpicMap[ j ] = i

```
  }
  }
  for( j = 0, k = 0; j <= num_slices_in_pic_minus1 && k < NumSlicesInSubpic[ i ]; j++ )
  if( SliceToSubpicMap[ j ] = = i )
```

SliceSubpicToPicIdx[ i ][ k++ ] = j

}

The variables SubpicLeft[ i ], SubpicTop[ i ], SubpicWidth, and SubpicHeight[ i ],
which specify the left boundary position, top boundary boundary position, width, and
height, respectively, of the i-th subpicture in units of CTBs are derived as follows for
each value of i in the range of 0 to NumSubPics − 1, inclusive:

SubpicLeft[ i ] = SliceColBd[ TopLeftSliceIdx[ i ] ]
SubpicWidth[ i ] = SliceColBd[ BottomRightSliceIdx[ i ] ] +

| | |
|---|---|
| SliceWidth[ BottomRightSliceIdx[ i ] ] − SubpicLeft[ i ] | (7-92) |

SubpicTop[ i ] = SliceColBd[ TopLeftSliceIdx[ i ] ]
SubpicHeight[ i ] = SliceColBd[ BottomRightSliceIdx[ i ] ] +

SliceHeight[ BottomRightSliceIdx[ i ] ] − SubpicTop[ i ]

subpic_treated_as_pic_flag[ i ] equal to 1 specifies that the i-th subpicture of each
coded picture in the CVS is treated as a picture in the decoding process excluding in-
loop filtering operations, subpic_treated_as_pic_flag[ i ] equal to 0 specifies that the
i-th subpicture of each coded picture in the CVS is not treated as a picture in the
decoding process excluding in-loop filtering operations. When not present, the value
of subpic_treated_as_pic_flag[ i ] is inferred to be equal to 0.
loop_filter_across_subpic_enabled_flag[ i ] equal to 1 specifies that in-loop
filtering operations may be performed across the boundaries of the i-th subpicture in
each coded picture in the CVS. loop_filter_across_subpic_enabled_flag[ i ] equal to 0
specifies that in-loop filtering operations are not performed across the boundaries of
the i-th subpicture in each coded picture in the CVS. When not present, the value of
loop_filter_across_subpic_enabled_pic_flag[ i ] is inferred to be equal to 1.
It is a requirement of bitstream conformance that the following constraints apply:

- For any two subpictures subpicA and subpicB, when the index of subpicA
is less than the index of subpicB, any coded NAL unit of subPicA shall
succeed any coded NAL unit of subPicB in decoding order.
- The shapes of the subpictures shall be such that each subpicture, when
decoded, shall have its entire left boundary and entire top boundary consisting
of picture boundaries or consisting of boundaries of previously decoded
subpictures.
- The values of SubpicLeft[ i ], SubpicTop[ i ], SubpicWidth[ i ] and
SubpicHeight[ i ] shall be the same, respectively for each value of i in the
range 0 to NumSubPics − 1, inclusive, regardless of which PPS RBSP
referenced by the coded slice NAL units of a CLVS they are derived from.
- The values of subpic_treated_as_pic_flag[ i ], and
loop_filter_across_subpic_enabled_flag[ i ] shall remain the same in all PPS
RBSPs referenced by the coded slice NAL units of a CLVS respectively for
each value of i in the range of 0 to NumSubPics − 1, inclusive.

subpic_ids_constant_in_clvs_flag equal to 1 indicates that subpic_id_len_minus1
and the values of pps_subpic_id[ i ], for each value of i in the range of 0 to
num_subpics_minus1, inclusive, remain the same in all PPS RBSPs referenced by the
coded slice NAL units of a CLVS. subpic_ids_constant_in_clvs_flag equal to 0
indicates that the values of subpic_id_len_minus1 the values of pps_subpic_id[ i ]
may or may not be constrained.
subpic_id_len_minus1 plus 1 specifies the length of the pps_subpic_id[ i ] and
slice_subpic_id syntax elements in bits. The value of subpic_id_len_minus1 shall be
in the range of 3 to 31, inclusive. The values of subpic_id_len_minus1 in the range of
0 to 2, inclusive, are reserved for future use by ITU-T | ISO/IEC.
pps_subpic_id[ i ] specifies the identifier of the i-th subpicture.

In another example, syntax changes to “JVET-P0126-v1_spec_BasedOnSlice.docx” with the signaling of the maximum number of subpictures in the SPS are presented in Table 14 below. Additions are marked between <ADD> and </ADD> and deletions are marked between <DELETE> and </DELETE>.

TABLE 14
7.3.2.4 PPS syntax in the document file “JVET-P0126-v1_spec_BasedOnSlice.docx”

| | | Descriptor |
|---|---|---|
| pic_parameter_set_rbsp( ) { | | |
| ... | | |
| if( rect_slice_flag 0 <ADD> && num_slices_in_pic_minus1 > 0 </ADD>) { | | |
| subpics_present_flag | | u(1) |
| if( subpics_present_flag ) { | | |
| <DELETE> if( num_slices_in_pic_minus1 > 0 ) </DELETE> | | |
| <ADD> if( num_slices_in_pic_minus1 > 1 ) </ADD> | | |
| | single_slice_per_subpic_flag | u(1) |
| | if( !single_slice_per_subpic_flag ) | |
| <DELETE> num_subpics_minus1 </DELETE> | | ue(v) |
| <ADD> num_subpics_minus2 </ADD> | | |
| <DELETE> if( num_subpics_minus1 > 0 ) </DELETE> | | |
| | if( !single_slice_per_subpic_flag ) { | |
| | bottom_right_slice_idx_length_minus1 | ue(v) |
| | for( i = 0; i < num_subpics_minus1; i++ ) { | |

| | |
|---|---|
| bottom_right_slice_idx_delta[ i ] | u(v) |
| if ( i > 0 ) | |
| slice_idx_delta_sign_flag[ i ] | u(1) |

| | |
|---|---|
| } | |
| } | |
| for( i = 0; i <= num_subpics_minus1; i++ ) { | |
| subpic_treated_as_pic_flag[ i ] | u(1) |
| loop_filter_across_subpic_enabled_flag[ i ] | u(1) |
| } | |
| } | |
| subpic_ids_constant_in_clvs_flag | u(1) |
| subpic_id_len_minus1 | ue(v) |
| for( i = 0; i <= num_subpics_minus1; i++ ) | |
| pps_subpic_id[ i ] | u(v) |

```
    }
  }
  ...
7.4.3.4 PPS semantics in the document file “JVET-P0126-
v1_spec_BasedOnSlice.docx”
subpics_present_flag equal to 1 indicates that subpicture parameters are present in
the present in the PPS RBSP syntax. subpics_present_flag equal to 0 indicates that
subpicture parameters are not present in the present in the PPS RBSP syntax. When
not present, the value of subpics_present_flag is inferred to be equal to 0.
    NOTE - When a bitstream is the result of a subpicture based sub-bitstream extraction process wherein
    the input bitstream contains multiple subpictures per picture and during the extraction VCL NAL units
    may only be extracted or discarded but not changed, and the bitstream contains only a true subset of
    the subpictures of the input bitstream, the value of subpics_present_flag has to be equal to 1 in the
    RBSP of the PPSs in the bitstream, even when there is only one subpicture in each picture.
single_slice_per_subpic_flag equal to 1 specifies that each subpicture in each picture
referring to this PPS includes one rectangular slice. single_slice_per_subpic_flag
equal to 0 specifies that a subpicture in a picture referring to this PPS may include
more than one rectangular slice. When rect_slice_flag is equal to 1 and
num_slices_in_pic_minus1 is equal to <DELETE> 0 </DELETE> <ADD> or smaller
than 1</ADD>, the value of single_slice_per_subpic_flag is inferred to be equal to 1.
<DELETE> num_subpics_minus1 plus 1 specifies the number of subpictures in
each picture referring to the PPS. num_subpics_minus1 shall be in the range of 0 to
num_slices_in_pic_minus1, inclusive. When subpics_present_flag is equal to 0, the
value of num_subpics_minus1 is inferred to 0. When not present and
single_slice_per_subpic_flag is equal to 1, the value of num_subpics_minus1 is
inferred to be equal to num_slices_in_pic_minus1. The variable NumSubPics is
derived to be equal to num_subpics_minus1 + 1. </DELETE>
<ADD> num_subpics_minus2 plus 2 specifies the number of subpictures in each
picture referring to the PPS. num_subpics_minus2 shall be in the range of 0 to
num_slices_in_pic_minus1 − 1, inclusive. When subpics_present_flag is equal to 0,
the value of num_subpics_minus2 is inferred to −1. When not present and
single_slice_per_subpic_flag is equal to 1, the value of num_subpics_minus2 is
inferred to be equal to num_slices_in_pic_minus1 − 1. The variable NumSubPics is
derived to be equal to num_subpics_minus2 + 2. </ADD>
bottom_right_slice_idx_length_minus1 plus 1 specifies the number of bits used to
represent the syntax element bottom_right_slice_idx_delta[ i ]. The value of
bottom_right_slice_idx_length_minus1 shall be in the range of 0 to
Ceil( Log2( num_slices_in_pic_minus1 + 1 ) ) − 1, inclusive.
bottom_right_slice_idx_delta[ i ] when i is greater than 0 specifies the difference
between the slice index of the slice located at the bottom-right corner of the i-th
subpicture and the slice index of the bottom-right corner of the ( i − 1 )-th subpicture.
bottom_right_slice_idx_delta[ 0 ] specifies the slice index of the bottom right corner
of the 0-th subpicture. When single_slice_per_subpic_flag is equal to 1, the value of
bottom_right_slice_idx_delta[ 0 ] is inferred to be equal to 0 and the value of
bottom_right_slice_idx_delta[ i ] is inferred to be equal to 1 for the values of i greater
than 0. The value of the BottomRightSliceIdk[ num_subpics_minus1 ] is inferred to
be equal to num_slices_in_pic_minus1. The length of the
bottom_right_slice_idx_delta[ i ] syntax element is
bottom_right_slice_idx_length_minus1 + 1 bits.
slice_idx_delta_sign_flag[ i ] equal to 1 indicates a positive sign for
bottom_right_slice_idx_delta[ i ]. slice_idx_delta_sign _flag[ i ] equal to 0 indicates a
negative sign for bottom_right_brick_idx_delta[ i ]. <ADD>When
single_slice_per_subpic_flag is equal to 1, the value of slice_idx_delta_sign_flag[ i ]
is inferred to be equal to 1 </ADD>
The variables TopLeftSliceIdk[ i ], BottomRightSliceIdk[ i ], NumSlicesInSubpic[ i ],
SliceToSubpicMap[ j ], and SliceSubpicToPicIdx[ i ][ k ], which specify the slice
index of the slice located at the top left corner of the i-th subpicture, the slice index of
the slice located at the bottom right corner of the i-th subpicture, the number of slices
in the i-th subpicture, the subpicture index of the subpicture containing the j-th slice,
and the picture-level slice index of the k-th slice in the i-th subpicture, respectively,
are derived as follows:
```

```
if( single_slice_per_subpic_flag ) {
  TopLeftSliceIdx[ i ] = i
  BottomRightSliceIdx[ i ] = i
  NumSlicesInSubpic[ i ] = 1
  SliceToSubpicMap[ i ] = i
  SliceSubpicToPicIdx[ i ][ 0 ] = 0
} else {
  for( j = 0; i = = 0 && j <= num_slices_in_pic_minus1; j++ )
  SliceToSubpicMap[ j ] = −1
  NumSlicesInSubpic[ i ] = 0
  if( i = = num_subpics_minus1 )
  BottomRightSliceIdx[ i ] = num_slices_in_pic_minus1
  else
  BottomRightSliceIdx[ i ] = i = = 0 ? bottom_right_slice_idx_delta[ i ] :
```

```
  ( BottomRightSliceIdx[ i − 1 ] + ( slice_idx_delta_sign_flag[ i ] ?
    bottom_right_slice_idx_delta[ i ] : −bottom_right_slice_idx_delta[ i ] ) )
```

| for( j = BottomRightSliceIdx[ i ]; j >= 0; j−− ) { | |
|---|---|
| if( SliceColBd[ j ] + SliceWidth[ j ] <= | |
| SliceColBd[ BottomRightSliceIdx[ i ] ] + SliceWidth[BottomRightSliceIdx[ i ] ] && | (7-43) |

SliceRowBd[ j ] + SliceHeight[ j ] <=

SliceRowBd[ BottomRightSliceIdx[ i ] ] + SliceHeight[BottomRightSliceIdx[ i ] ] &&

SliceToSubpicMap[ j ] = = −1 ) {
TopLeftSliceIdx[ i ] = j
NumSlicesInSubpic[ i ]++
SliceToSubpicMap[ j ] = i

```
  }
  }
  for( j = 0, k = 0; j <= num_slices_in_pic_minus1 && k < NumSlicesInSubpic[ i ]; j++ )
  if( SliceToSubpicMap[ j ] == i )
```

SliceSubpicToPicIdx[ i ][ k++ ] = j

}

The variables SubpicLeft[ i ], SubpicTop[ i ], SubpicWidth, and SubpicHeight[ i ],
which specify the left boundary position, top boundary boundary position, width, and
height, respectively, of the i-th subpicture in units of CTBs are derived as follows for
each value of i in the range of 0 to NumSubPics − 1, inclusive:

SubpicLeft[ i ] = SliceColBd[ TopLeftSliceIdx[ i ] ]
SubpicWidth[ i ] = SliceColBd[ BottomRightSliceIdx[ i ] ] +

| | |
|---|---|
| SliceWidth[ BottomRightSliceIdx[ i ] ] − SubpicLeft[ i ] | (7-92) |

SubpicTop[ i ] = SliceColBd[ TopLeftSliceIdx[ i ] ]
SubpicHeight[ i ] = SliceColBd[ BottomRightSliceIdx[ i ] ] +

SliceHeight[ BottomRightSliceIdx[ i ] ] − SubpicTop[ i ]

subpic_treated_as_pic_flag[ i ] equal to 1 specifies that the i-th subpicture of each
coded picture in the CVS is treated as a picture in the decoding process excluding in-
loop filtering operations, subpic_treated_as_pic_flag[ i ] equal to 0 specifies that the
i-th subpicture of each coded picture in the CVS is not treated as a picture in the
decoding process excluding in-loop filtering operations. When not present, the value
of subpic_treated_as_pic_flag[ i ] is inferred to be equal to 0.
loop_filter_across_subpic_enabled_flag[ i ] equal to 1 specifies that in-loop
filtering operations may be performed across the boundaries of the i-th subpicture in
each coded picture in the CVS. loop_filter_across_subpic_enabled_flag[ i ] equal to 0
specifies that in-loop filtering operations are not performed across the boundaries of
the i-th subpicture in each coded picture in the CVS. When not present, the value of
loop_filter_across_subpic_enabled_pic_flag[ i ] is inferred to be equal to 1.
It is a requirement of bitstream conformance that the following constraints apply:

- For any two subpictures subpicA and subpicB, when the index of subpicA
is less than the index of subpicB, any coded NAL unit of subPicA shall
succeed any coded NAL unit of subPicB in decoding order.
- The shapes of the subpictures shall be such that each subpicture, when
decoded, shall have its entire left boundary and entire top boundary consisting
of picture boundaries or consisting of boundaries of previously decoded
subpictures.
- The values of SubpicLeft[ i ], SubpicTop[ i ], SubpicWidth[ i ] and
SubpicHeight[ i ] shall be the same, respectively for each value of i in the
range 0 to NumSubPics − 1, inclusive, regardless of which PPS RBSP
referenced by the coded slice NAL units of a CLVS they are derived from.
- The values of subpic_treated_as_pic_flag[ i ], and
loop_filter_across_subpic_enabled_flag[ i ] shall remain the same in all PPS
RBSPs referenced by the coded slice NAL units of a CLVS respectively for
each value of i in the range of 0 to NumSubPics − 1, inclusive.

subpic_ids_constant_in_clvs_flag equal to 1 indicates that subpic_id_len_minus1
and the values of pps_subpic_id[ i ], for each value of i in the range of 0 to
num_subpics_minus1, inclusive, remain the same in all PPS RBSPs referenced by the
coded slice NAL units of a CLVS. subpic_ids_constant_in_clvs_flag equal to 0
indicates that the values of subpic_id_len_minus1 the values of pps_subpic_id[ i ]
may or may not be constrained.
subpic_id_len_minus1 plus 1 specifies the length of the pps_subpic_id[ i ] and
slice_subpic_id syntax elements in bits. The value of subpic_id_len_minus1 shall be
in the range of 3 to 31, inclusive. The values of subpic_id_len_minus1 in the range of
0 to 2, inclusive, are reserved for future use by ITU-T | ISO/IEC.
pps_subpic_id[ i ] specifies the identifier of the i-th subpicture.

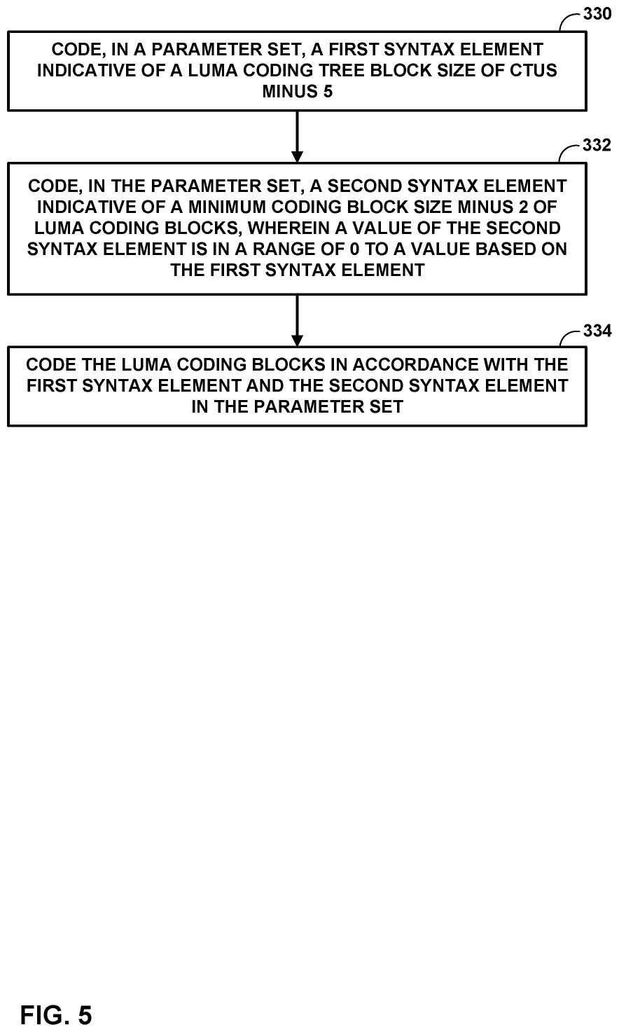

FIG. 5 is a flowchart illustrating a method of signaling according to the techniques of this disclosure. Video encoder 200 or video decoder 300 may code (encode or decode, respectively), in a parameter set, a first syntax element indicative of a luma coding tree block size of CTUs to which the parameter set is applicable minus 5 (330). For example, video encoder 200 may encode and signal, in a parameter set, log2_ctu_size_minus5 and video decoder 300 may parse log2_ctu_size_minus5. In some examples, the parameter set is an SPS.

Video encoder 200 or video decoder 300 may code (encode or decode, respectively), in the parameter set, a second syntax element indicative of a minimum luma coding block size minus 2 of luma coding blocks to which the parameter set is applicable, wherein a value of the second syntax element is in a range of 0 to a value based on the first syntax element, inclusive (322). For example, video encoder 200 may encode and signal, in the parameter set, log2_min_luma_coding_block_size_minus2 and video decoder 300 may parse log2_min_luma_coding_block_size_minus2. In some examples, video encoder 200 may restrict the value of the second syntax element to be in the range of 0 to the value based on the first syntax element, inclusive. In some examples, the value based on the first syntax element includes a value of the first syntax element plus 3. In some examples, the value based on the first syntax element includes a minimum of (i) 4 and (ii) a value of the first syntax element plus 3 (e.g., 0 to min(4, log2_ctu_size_minus5+3)).

Video encoder 200 or video decoder 300 may code (encode or decode, respectively) the luma coding blocks in accordance with the first syntax element and the second syntax element (334). For example, video encoder 200 may encode the luma coding blocks in accordance with the first syntax element and the second syntax element and video decoder 300 may decode the luma coding blocks in accordance with the first syntax element and the second syntax element in the parameter set.

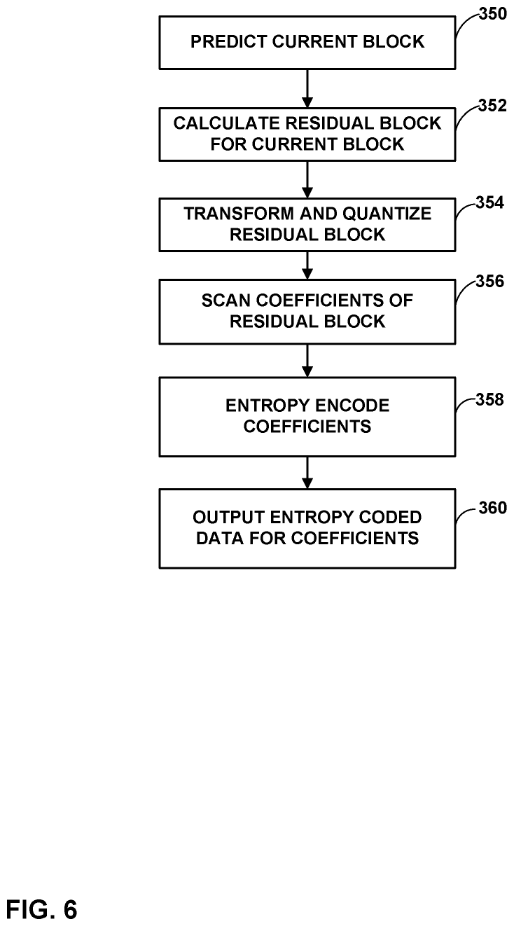

FIG. 6 is a flowchart illustrating an example method for encoding a current block. The current block may comprise a current CU. Although described with respect to video encoder 200 (FIGS. 1 and 3), it should be understood that other devices may be configured to perform a method similar to that of FIG. 6.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform and quantize coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

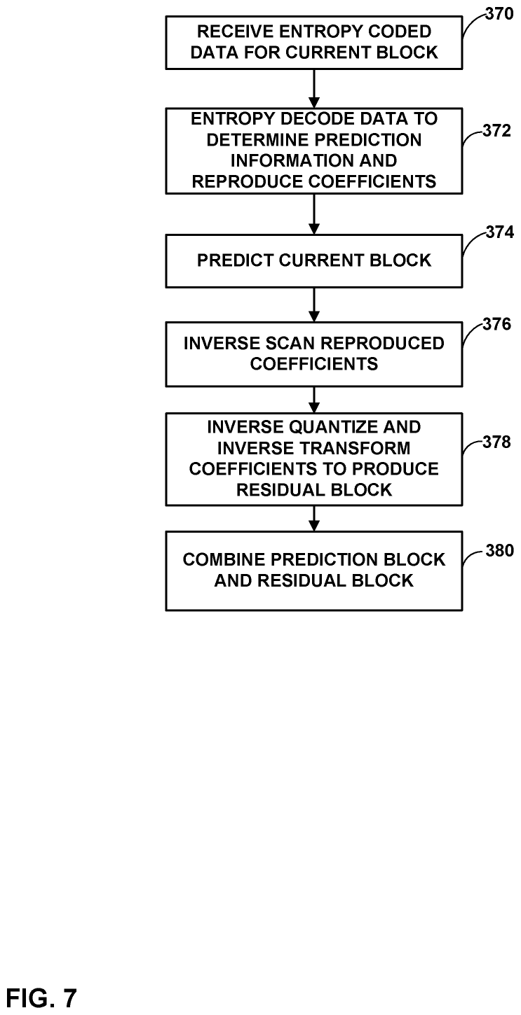

FIG. 7 is a flowchart illustrating an example method for decoding a current block of video data. The current block may comprise a current CU. Although described with respect to video decoder 300 (FIGS. 1 and 4), it should be understood that other devices may be configured to perform a method similar to that of FIG. 7.

Video decoder 300 may receive entropy encoded data for the current block, such as entropy encoded prediction information and entropy encoded data for coefficients of a residual block corresponding to the current block (370). Video decoder 300 may entropy decode the entropy encoded data to determine prediction information for the current block and to reproduce coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced coefficients (376), to create a block of quantized transform coefficients. Video decoder 300 may then inverse quantize and inverse transform the transform coefficients to produce a residual block (378). Video decoder 300 may ultimately decode the current block by combining the prediction block and the residual block (380).

This disclosure contains the following examples.

Example 1. A method of coding video data, the method comprising:

coding, in a parameter set, a first syntax element indicative of a luma coding tree block size of coding tree units (CTUs) to which the parameter set is applicable minus 5;
coding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and coding the luma coding blocks to which the parameter set is applicable in accordance with the first syntax element and the second syntax element in the parameter set.

Example 2. The method of example 1, wherein the value of the second syntax element is restricted to be in the range of 0 to the value based on the first syntax element, inclusive.

Example 3. The method of any combination of examples 1-2, wherein the value based on the first syntax element comprises a value of the first syntax element plus 3.

Example 4. The method of any combination of examples 1-3, wherein the value based on the first syntax element comprises a minimum of (i) 4 and (ii) a value of the first syntax element plus 3.

Example 5. The method of any combination of examples 1-4, wherein the first syntax element comprises log2_ctu_size_minus5 and the second syntax element comprises log2_min_luma_coding_block_size_minus2.

Example 6. The method of any combination of examples 1-5, wherein the parameter set comprises a sequence parameter set.

Example 7. A method of coding video data, the method comprising: restricting a size of MinCbSizeY to be smaller than or equal to a size of CtbSizeY; and coding the video data based on MinCbSizeY and CtbSizeY.

Example 8. A method of coding video data, the method comprising: restricting a size of MinCbLog2SizeY to be smaller than or equal to a size of CtbLog2SizeY; and coding the video data based on MinCbLog2SizeY and CtbLog2SizeY.

Example 9. The method of example 7, further comprising restricting the value of log2_min_luma_coding_block_size_minus2 to be in the range of 0 to log2_ctu_size_minus5+three, inclusive.

Example 10. The method of any combination of examples 7-8, further comprising: using log2_diff_max_min_luma_coding_block_size to signal a difference between a maximum luma coding block size and a minimum luma coding block size; and deriving a base 2 logarithm of the minimum luma coding block size by subtracting log2_diff_max_min_luma_coding_block_size from log2_ctu_size_minus5.

Example 11. A method of coding video data, the method comprising:

determining whether MinCbLog2SizeY is larger than five; if MinCbLog2SizeY is larger than five, setting a value of sps_transform_skip_enabled_flag to zero; and coding the video data based upon sps_transform_skip_enabled_flag and MinCbLog2SizeY.

Example 12. A method of coding video data, the method comprising:

determining whether MinCbLog2SizeY is larger than five; if MinCbLog2SizeY is larger than five, inferring sps_transform_skip_enabled_flag to be zero; and coding the video data based upon sps_transform_skip_enabled_flag and MinCbLog2SizeY.

Example 13. A method of coding video data, the method comprising:

determining whether sps_transform_skip_enabled_flag is present; if sps_transform_skip_enabled_flag is not present, inferring sps_transform_skip_enabled_flag to be zero; and coding the video data based upon sps_transform_skip_enabled_flag.

Example 14. A method of coding video data, the method comprising: coding, in a parameter set, a first syntax element that indicates a luma coding tree block size of all coding tree units (CTUs) to which the parameter set is applicable minus 5; coding, in the parameter set, a second syntax element that indicates a minimum luma coding block size minus 2 of luma coding blocks to which the parameter set is applicable, wherein a value of the second syntax element is required to be in a range of 0 to a minimum of (i) 4 and (ii) a value of the first syntax element plus 3, inclusive; and coding the luma coding blocks to which the parameter set is applicable in accordance with the first syntax element and the second syntax element.

Example 15. A method of coding video data, the method comprising: coding, in a parameter set, a first syntax element that indicates a luma coding tree block size of all coding tree units (CTUs) to which the parameter set is applicable minus 5; coding, in the parameter set, a second syntax element that indicates a minimum luma coding block size minus 2 of luma coding blocks to which the parameter set is applicable, wherein a value of the second syntax element is required to be in a range of 0 to a minimum of (i) a variable and (ii) a value of the first syntax element plus 3, inclusive, wherein the variable is 4 or 5 depending on whether, for I slices to which the parameter set is applicable, each CTU is split into coding units with 64×64 luma samples using an implicit quadtree split and that these coding units are a root of two separate coding_tree syntax structures for luma and chroma, or whether separate a coding_tree syntax structure is not used for the I slices to which the parameter set is applicable; and coding the luma coding blocks to which the parameter set is applicable in accordance with the first syntax element and the second syntax element.

Example 16. A method of coding video data, the method comprising: coding, in a parameter set, a first syntax element that indicates a luma coding tree block size minus 5 for all coding tree units (CTUs) to which the parameter set is applicable; coding, in the parameter set, a second syntax element that indicates a minimum luma coding block size minus 2 of luma coding blocks to which the parameter set is applicable, wherein a value of the second syntax element is required to be in a range of 0 to a minimum of (i) 4 and (ii) a value of the first syntax element plus 3, inclusive; and based on the video data not being coded using separate color planes and a value of the second syntax element being less than 5, coding a third syntax element in the parameter set, wherein the third syntax element specifies whether, for I slices to which the parameter set is applicable, each CTU is split into coding units with 64×64 luma samples using an implicit quadtree split and that these coding units are a root of two separate coding_tree syntax structures for luma and chroma, or whether separate a coding_tree syntax structure is not used for the I slices to which the parameter set is applicable; and coding the luma coding blocks to which the parameter set is applicable in accordance with the first syntax element and the second syntax element.

Example 17. A method of coding video data, the method comprising: coding, in a sequence parameter set, a first syntax element that specifies a maximum number of subpictures that may be present in a coded video sequence to which the sequence parameter set is applicable, minus 2; coding, in a picture parameter set to which the sequence parameter set is applicable, a second syntax element that specifies a number of slices in each picture to which the picture parameter set is applicable, minus 1; coding, in the picture parameter, a third syntax element that specifies a maximum number of subpictures that may be present in pictures to which the picture parameter set is applicable, minus 2, wherein the third syntax element is required to be in a range of 0 to a minimum of (i) the second syntax element minus 1 and (ii) the first syntax element, inclusive; and coding the pictures to which the parameter set is applicable in accordance with the first, second, and third syntax elements.

Example 18. A method of coding video data, the method comprising: coding, in a picture parameter set, a first syntax element that specifies a number of slices in each picture to which the picture parameter set is applicable, minus 1; based on the first syntax element having a value greater than 1, coding, in the picture parameter set, a second syntax element that specifies whether each subpicture in each picture to which the picture parameter set is applicable includes only one rectangular slice or may include more than one rectangular slice; based on the second syntax element indicating that each subpicture in each picture to which the picture parameter set is applicable may include more than one rectangular slice, coding, in the picture parameter set, a third syntax element that specifies a number of subpictures in each picture to which the picture parameter set is applicable, minus 2, wherein the third syntax element is required to be in a range of 0 to a minimum of (i) the second syntax element minus 1 and (ii) the value of the first syntax element, inclusive; and coding the pictures to which the picture parameter set is applicable in accordance with the first, second, and third syntax elements.

Example 19. A method of coding video data, the method comprising:

determining a first value, the first value being a luma coding tree block size of all coding tree units (CTUs) to which a sequence parameter set is applicable; determining a second value, the second value being a minimum luma coding block size for each of the CTUs to which the sequence parameter set is applicable; based on the first value being less than or equal to 5 or the second value being greater than or equal to 6: skipping coding a syntax element indicating whether a maximum transform size in luma samples is equal to 64 or equal to 32; and determining that the maximum transform size in luma samples so that the maximum transform size in luma samples is equal to 32 when the first value is greater than 5 and equal to 64 when the second value is less than 6; and coding the pictures to which the sequence parameter set is applicable in accordance with the syntax element.

Example 20. A method of coding video data, the method comprising:

determining a first value, the first value being a luma coding tree block size of all coding tree units (CTUs) to which a sequence parameter set is applicable; determining a second value, the second value being a minimum luma coding block size for each of the CTUs to which the sequence parameter set is applicable; based on the first value being less than or equal to 5 or the second value greater than or equal to 6, skipping coding of a first syntax element indicating whether a maximum transform size in luma samples is equal to 64 or equal to 32 and determining a value of the first syntax element, wherein: the first syntax element indicates whether a maximum transform size in luma samples is equal to 64 or equal to 32, based on coding of the first syntax element being skipped and the first value being greater than 5, the value of the first syntax element is inferred to indicate that the maximum transform size in luma samples is 32, and based on coding of the first syntax element being skipped and the second value being less than 6, the value of the first syntax element is inferred to indicate that the maximum transform size in luma samples is 64; coding, in the sequence parameter set, a second syntax element indicating whether a transform skip flag may be present in transform unit syntax of transform units to which the sequence parameter set is applicable; based on the second value being less than 6 and the first syntax element indicating that the maximum transform size in luma samples is equal to 64 and that the second syntax element indicates that the transform skip flag may be present in the transform unit syntax of transform units to which the sequence parameter set is applicable, skipping coding of a third syntax element that indicates whether a maximum block size used for transform skip is 32 or 64 and inferring that the third syntax element indicates that the maximum block size used for transform skip is 64; and coding the pictures to which the sequence parameter set is applicable in accordance with the first syntax element, the second syntax element, and the third syntax element.

Example 21. The method of any combination of examples 1-20, wherein coding comprises decoding.

Example 22. The method of any combination of examples 1-21, wherein coding comprises encoding.

Example 23. A device for coding video data, the device comprising one or more means for performing the method of any of examples 1-22.

Example 24. The device of example 23, wherein the one or more means comprise one or more processors implemented in circuitry.

Example 25. The device of any of examples 23 or 24, further comprising a memory to store the video data.

Example 26. The device of any combination of examples 23-25, further comprising a display configured to display decoded video data.

Example 27. The device of any combination of examples 23-26, wherein the device comprises one or more of a camera, a computer, a mobile device, a broadcast receiver device, or a set-top box.

Example 28. The device of any combination of examples 23-27, wherein the device comprises a video decoder.

Example 29. The device of any combination of examples 23-28, wherein the device comprises a video encoder.

Example 30. A computer-readable storage medium having stored thereon instructions that, when executed, cause one or more processors to perform the method of any of examples 1-22.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding video data, the method comprising:
encoding, in a parameter set, a first syntax element indicative of a luma coding tree block size of coding tree units (CTUs) to which the parameter set is applicable minus 5;
encoding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and
encoding the luma coding blocks to which the parameter set is applicable in accordance with the first syntax element and the second syntax element in the parameter set.

2. The method of claim 1, wherein the value of the second syntax element is restricted to be in the range of 0 to the value based on the first syntax element, inclusive.

3. The method of claim 1, wherein the value based on the first syntax element comprises a value of the first syntax element plus 3.

4. The method of claim 1, wherein the value based on the first syntax element comprises a minimum of (i) 4 and (ii) a value of the first syntax element plus 3.

5. The method of claim 1, wherein the first syntax element comprises log2_ctu_size_minus5 and the second syntax element comprises log2_min_luma_coding_block_size_minus2.

6. The method of claim 1, wherein the parameter set comprises a sequence parameter set.

7. A method of decoding video data, the method comprising:
decoding, in a parameter set, a first syntax element indicative of a luma coding tree block size of coding tree units (CTUs) to which the parameter set is applicable minus 5;
decoding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and
decoding the luma coding blocks to which the parameter set is applicable in accordance with the first syntax element and the second syntax element in the parameter set.

8. The method of claim 7, wherein the value of the second syntax element is restricted to be in the range of 0 to the value based on the first syntax element, inclusive.

9. The method of claim 7, wherein the value based on the first syntax element comprises a value of the first syntax element plus 3.

10. The method of claim 7, wherein the value based on the first syntax element comprises a minimum of (i) 4 and (ii) a value of the first syntax element plus 3.

11. The method of claim 7, wherein the first syntax element comprises log2_ctu_size_minus5 and the second syntax element comprises log2_min_luma_coding_block_size_minus2.

12. The method of claim 7, wherein the parameter set comprises a sequence parameter set.

13. A device for encoding video data, the device comprising:
memory configured to store the video data; and
one or more processors implemented in circuitry and communicatively coupled to the memory, the one or more processors being configured to:
encode, in a parameter set, a first syntax element indicative of a luma coding tree block size of coding tree units (CTUs) to which the parameter set is applicable minus 5;
encode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and
encode the luma coding blocks to which the parameter set is applicable in accordance with the first syntax element and the second syntax element in the parameter set.

14. The device of claim 13, wherein the value of the second syntax element is restricted to be in the range of 0 to the value based on the first syntax element, inclusive.

15. The device of claim 13, wherein the value based on the first syntax element comprises a value of the first syntax element plus 3.

16. The device of claim 13, wherein the value based on the first syntax element comprises a minimum of (i) 4 and (ii) a value of the first syntax element plus 3.

17. The device of claim 13, wherein the first syntax element comprises log2_ctu_size_minus5 and the second syntax element comprises log2_min_luma_coding_block_size_minus2.

18. The device of claim 13, wherein the parameter set comprises a sequence parameter set.

19. The device of claim 13, further comprising:
a camera, the camera being configured to capture the video data.

20. A device for decoding video data, the device comprising:
memory configured to store the video data; and
one or more processors implemented in circuitry and communicatively coupled to the memory, the one or more processors being configured to:
decode, in a parameter set, a first syntax element indicative of a luma coding tree block size of coding tree units (CTUs) to which the parameter set is applicable minus 5;
decode, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and
decode the luma coding blocks to which the parameter set is applicable in accordance with the first syntax element and the second syntax element in the parameter set.

21. The device of claim 20, wherein the value of the second syntax element is restricted to be in the range of 0 to the value based on the first syntax element, inclusive.

22. The device of claim 20, wherein the value based on the first syntax element comprises a value of the first syntax element plus 3.

23. The device of claim 20, wherein the value based on the first syntax element comprises a minimum of (i) 4 and (ii) a value of the first syntax element plus 3.

24. The device of claim 20, wherein the first syntax element comprises log2_ctu_size_minus5 and the second syntax element comprises log2_min_luma_coding_block_size_minus2.

25. The device of claim 20, wherein the parameter set comprises a sequence parameter set.

26. The device of claim 20, further comprising:
a display, the display being configured to display the video data.

27. A non-transitory computer-readable storage medium having stored thereon instructions that, when executed, cause one or more processors to:
code, in a parameter set, a first syntax element indicative of a luma coding tree block size of coding tree units (CTUs) to which the parameter set is applicable minus 5;
code, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and
code the luma coding blocks to which the parameter set is applicable in accordance with the first syntax element and the second syntax element in the parameter set.

28. A device for video coding, the device comprising:
means for coding, in a parameter set, a first syntax element indicative of a luma coding tree block size of coding tree units (CTUs) to which the parameter set is applicable minus 5;
means for coding, in the parameter set, a second syntax element indicative of a minimum luma coding block size minus 2 of luma coding blocks to which the parameter set is applicable, wherein a value of the second syntax element is in a range of 0 to a value based on the first syntax element, inclusive; and
means for coding the luma coding blocks to which the parameter set is applicable in accordance with the first syntax element and the second syntax element in the parameter set.
